(19) United States
(12) Patent Application Publication
(10) Pub. No.: US 2014/0358427 A1
(43) Pub. Date: Dec. 4, 2014

(54) ENHANCING DRIVING NAVIGATION VIA PASSIVE DRIVERS FEEDBACK

(71) Applicant: Oded Fuhrman, Cupertino, CA (US)

(72) Inventor: Oded Fuhrman, Cupertino, CA (US)

(73) Assignee: GOOGLE INC., Mountain View, CA (US)

(21) Appl. No.: 12/966,272

(22) Filed: Dec. 13, 2010

(51) Int. Cl. G01C 21/36

(52) U.S. Cl. 701/452; 701/488

(57) ABSTRACT

The invention relates generally to an enhanced navigation system for generating turn-by-turn directions. More specifically, according to an aspect of the invention, the navigation system receives and interprets feedback in order to assist the user in following the turn-by-turn directions. For example, a navigation device may identify the next action to be taken, determine whether the driver is taking appropriate steps to perform the action, and provide feedback to the driver when necessary to remind the driver to take the next action.

### BACKGROUND OF THE INVENTION

Various navigation systems provide users with turn-by-turn directions. These systems include handheld GPS devices, mobile phones, vehicle-mounted devices, or other computers with access to mapping websites. In such systems, users input one or more locations and receive a route and turn-by-turn directions. The user may then follow the turn-by-turn directions to reach the one or more locations.

In navigation systems which include portable devices such as handheld or vehicle-mounted devices, the device may provide instructions visually and/or audibly in order to assist the driver follow the route and turn-by-turn directions. For example, as the device (or vehicle) approaches an exit, the device may display various images of the exit and play an audible reminder to use the exit. These repeated instructions may become annoying to drivers who may, in some examples, choose to ignore them.

Some navigation systems also include “lane assist” features. For example, the device may display the lanes of a roadway and an icon or arrow over the lane in which the vehicle should be driving in order to follow the route. However, when displaying the information, these devices do not consider where the vehicle actually is, only where the vehicle should be.

### BRIEF SUMMARY OF THE INVENTION

The invention relates generally to an enhanced navigation system for generating turn-by-turn directions. More specifically, according to an aspect of the invention, the navigation system receives and interprets feedback in order to assist the user in following the turn-by-turn directions. For example, a navigation device may identify the next action to be taken, determine whether the driver is taking appropriate steps to perform the action, and provide feedback to the driver when necessary to remind the driver to take the next action.

One aspect of the invention provides a method of providing a reminder to a user of a navigation device. The method includes receiving a destination location; periodically determining, by a processor, a current location of the navigation device; determining a route including an ordered set of turn-by-turn directions based on the destination location and the current location of the navigation device, each turn-by-turn direction being associated with a geolocation and an action; identifying a particular turn-by-turn direction of the ordered set of turn-by-turn directions based on the current location of the navigation device; determining a current speed of the navigation device; determining a threshold distance to the geolocation associated with the particular turn-by-turn direction based on the current speed of the navigation device and the action associated with the particular turn-by-turn direction; receiving input from a feedback device; if the current location of the navigation device is not within the threshold distance of the geographic location associated with the particular turn-by-turn direction, determining based on the input from the feedback device whether the navigation device has taken a step towards performing the action associated with the particular turn-by-turn direction; and if the navigation device has not taken a set towards performing the action associated with the particular turn-by-turn direction, generating a reminder to inform the user that the action associated with the particular turn-by-turn direction must be completed.

In one example, the reminder is an audible reminder and the method further includes playing the reminder through a speaker of the navigation device. In another example, the reminder is an visual reminder and the method further includes displaying the reminder on a display of the navigation device. In another example, the step is turning on a turn signal. In another example, the step is decelerating the navigation device. In another example, the step is receiving a verbal command at a microphone of the navigation device. In another example, the action is turning onto a roadway. In another example, the action is exiting a roadway. In another example, the threshold distance is a distance along the route. In another example, the threshold distance is determined based on the road conditions.

Another aspect of the invention provides a computer. The computer includes memory, a geographic positioning device for determining a current location of the computer, and a processor coupled to the memory. The processor is operable to receive a destination location; determine a route including an ordered set of turn-by-turn directions based on the destination location and the current location of the computer as determined by the geographic positioning device, each turn-by-turn direction being associated with a geolocation and an action; identify a particular turn-by-turn direction of the ordered set of turn-by-turn directions based on the current location of the computer as determined by the geographic positioning device; determining a current speed of the navigation device; determine a threshold distance to the geolocation associated with the particular turn-by-turn direction based on the current speed of the computer and the action associated with the particular turn-by-turn direction; receive input from a feedback device; if the current location of the navigation device is not within the threshold distance of the geographic location associated with the particular turn-by-turn direction, determine based on the input from the feedback device whether the computer has taken a step towards performing the action associated with the particular turn-by-turn direction; and if the navigation device has not taken a set towards perform the action associated with the particular turn-by-turn direction, generating a reminder to inform a user that the action associated with the particular turn-by-turn direction must be completed.

In one example, the computer also includes a speaker and the reminder is an audible reminder and the processor is further operable to play the reminder through the speaker. In another example, the computer also includes a display and the reminder is a visual reminder and the processor is further operable to display the reminder on the display. In another example, the step is turning on a turn signal. In another example, the step is decelerating the navigation device. In another example, the step is receiving a verbal command at a microphone of the navigation device. In another example, the action is turning onto a roadway. In another example, the action is exiting a roadway. In another example, the threshold distance is a distance along the route. In another example, the threshold distance is determined based on the road conditions.

### BRIEF DESCRIPTION OF THE DRAWINGS

FIG. 1 is a functional diagram of a system in accordance with aspects of the invention.

FIG. 2 is a pictorial diagram of the system of FIG. 1.

FIG. 3 is an exemplary map in accordance with an aspect of the invention.

FIG. 4 is another exemplary map in accordance with another aspect of the invention.

FIG. 5 is yet another exemplary map in accordance with a further aspect of the invention.

FIG. 6 is a further exemplary map in accordance with another aspect of the invention.

FIG. 7 is still a further exemplary map in accordance with a further aspect of the invention.

FIG. 8 is a flow chart in accordance with aspects of the invention.

### DETAILED DESCRIPTION

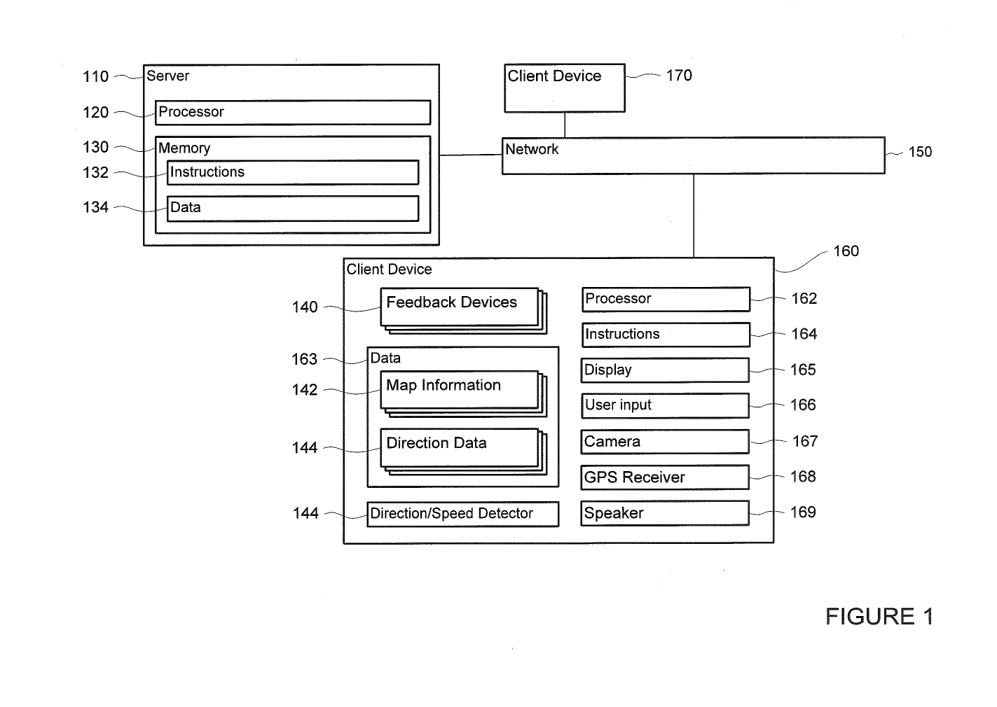

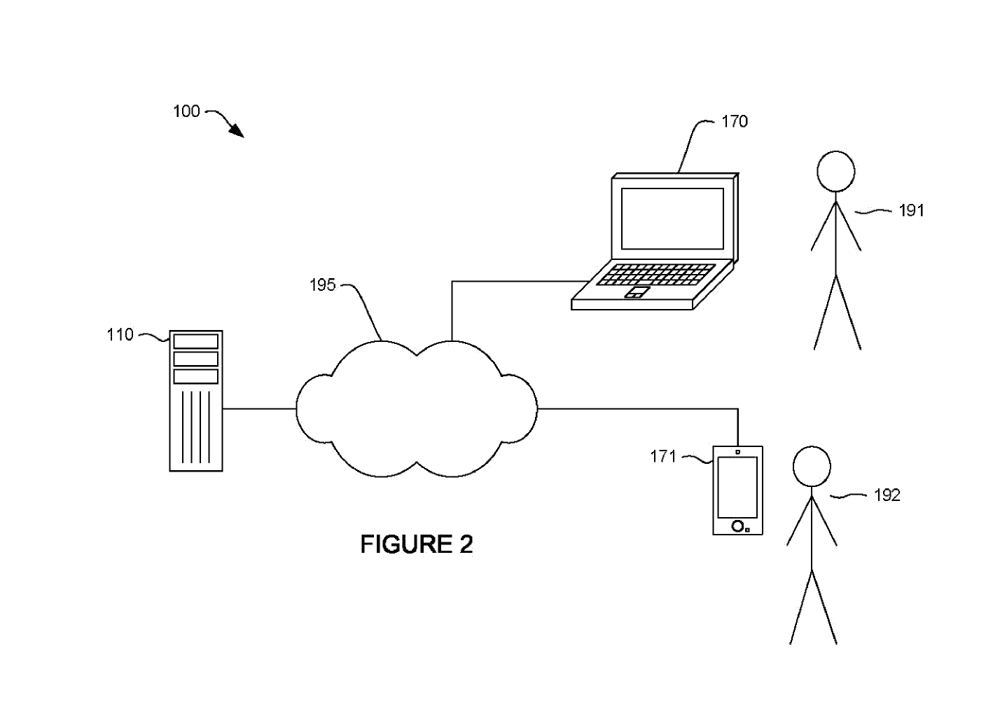

As shown in FIGS. 1-2, a system 100 in accordance with one aspect of the invention includes a computer 110 containing a processor 120, memory 130 and other components typically present in general purpose computers.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, memory may include short term or temporary storage as well as long term or persistent storage. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the architecture is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data may comprise any information sufficient to identify the relevant information, such as numbers, descriptive text, proprietary codes, references to data stored in other areas of the same memory or different memories (including other network locations or servers) or information that is used by a function to calculate the relevant data.

The processor 120 may be any conventional processor, such as processors from Intel Corporation or Advanced Micro Devices. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor or computer will be understood to include references to a collection of processors or computers or memories that may or may not operate in parallel.

Computer 110 may be at one node of a network 150 and capable of directly and indirectly receiving data from other nodes of the network. For example, computer 110 may comprise a web server that is capable of receiving data from client devices 160 and 170 via network 150 such that server 110 uses network 150 to transmit and display information to a user on display 165 of client device 170. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

Network 150, and intervening nodes between server 110 and client devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 1-2, it should be appreciated that a typical system can include a large number of connected computers.

Each client device may be configured similarly to the server 110, with a processor, memory and instructions as described above. Each client device 160 or 170 may be a personal computer intended for use by a person 191-192, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or any other electrical device that is operable to display information), and user input 166 (e.g., a mouse, keyboard, touch-screen or microphone). The client device may also include a camera 167, position component 168, accelerometer (not shown), one or more speakers 169, a network interface device (not shown), a battery power supply or other power source (not shown), and all of the components used for connecting these elements to one another.

Although the client devices 160 and 170 may each comprise a full-sized personal computer, they may alternatively comprise mobile devices capable of wirelessly exchanging data with a server over a network such as the Internet. By way of example only, client device 160 may be a wireless-enabled PDA or a cellular phone capable of obtaining information via the Internet. The user may input information using a small keyboard, a keypad or a touch screen. In still other examples, the client device may be a vehicle-mounted computer or may be a mobile computing device which may be placed in a mount within the vehicle.

Although certain advantages are obtained when information is transmitted or received as noted above, other aspects of the system and method are not limited to any particular manner of transmission of information. For example, in some aspects, information may be sent via a medium such as an optical disk or portable drive. In other aspects, the information may be transmitted in a non-electronic format and manually entered into the system. Yet further, although some functions are indicated as taking place on a server and others on a client, various aspects of the system and method may be implemented by a single computer having a single processor and vice versa.

As shown in FIG. 1, the client devices may also include geographic position component 168, to determine the geographic location and orientation of the device. For example, geographic position component 168 may be a GPS receiver to determine the device's latitude, longitude and altitude position. The geographic position component may also comprise software for determining the position of the device based on other signals received at the client device 160, such as signals received at a cell phone's antennas from one or more cell phone towers.

The client device may also include other features such as an accelerometer, gyroscope, or other direction/speed detection device to determine the direction and speed of the client device. By way of example only, the device may determine its pitch, yaw or roll (or changes thereto) relative to the direction of gravity or a plane perpendicular thereto. In that regard, it will be understood that a client device's provision of location and orientation data as set forth herein may be provided automatically to the user, to the server, and combinations of the foregoing.

The client device may also receive input from various feedback devices 140. These feedback devices may be incorporated into the client device, hardwired or removably connected to the client device, or transmit information wirelessly to the client device. Examples of feedback devices may include touch-sensitive inputs, cameras, microphones, GPS or similar devices, accelerometers, or radar which may detect the client device's position and/or direction along a roadway, actions or the driver, movement of the steering wheel, use of a turn signal in a vehicle, etc. For example, if the client device is incorporated into a vehicle, the client device may include a wired connection to the turn signal, a microphone located proximate to the turn signal, and/or a camera for identifying whether the turn signal has been activated. In another example, the client device may include a microphone and voice recognition software for receiving audible user input, for example, the driver acknowledging that he is going to make a turn, the driver has stopped talking, or a passenger mentioning that the driver will need to make a turn. In yet another example, a camera may be used to monitor whether the driver's hands move the steering wheel or move towards a turn signal. Cameras may also be used to determine if the steering wheel turns or if the car changed lanes. In another example, a sensor in the steering wheel may be used to determine whether the wheel has turned or a sensor in the turn signal may determine whether the turn signal has been activated. In other examples, a GPS device, radar, or an accelerometer may be used to determine if the client device or the vehicle has begin to turn.

Client device 160 may store map information 142, at least a portion of which may be transmitted to the client device. For example, the map information may include highly detailed maps identifying the shape and elevation of roadways, lane lines, intersections, and respective geolocation information. The client device may use this information to identify a route between locations. The map information may also be used to determine the location of the client device, with respect to the map for example, by comparing a current geolocation from the geographic position component to the map information. In some examples, the map information may also be used in conjunction with the feedback devices to increase the accuracy of the location of the client device.

The map information may also include geolocated image information. For example, map information 140 may include map tiles, where each tile is a map image of a particular geographic area. A single tile may cover an entire region such as a state in relatively little detail and another tile may cover just a few streets in high detail. In that regard, a single geographic point may be associated with multiple tiles, and a tile may be selected for transmission based on the desired level of zoom. The map information is not limited to any particular format. For example, the images may comprise street maps, satellite images, or a combination of these, and may be stored as vectors (particularly with respect to street maps) or bitmaps (particularly with respect to satellite images). The various map tiles, images and vectors may each be associated with geographical locations, such that server 110 and/or the client device are capable of selecting, retrieving, transmitting, or displaying image information in response to receiving a geographical location.

The system and method may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is capable of identifying a geographic locations (e.g., lot and block numbers on survey maps). Moreover, a location may define a range of the foregoing. The systems and methods herein may further translate locations from one reference system to another. For example, the client 160 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other references systems as well.

The client device may also access direction data 144 for generating turn-by-turn directions based on an initial geographic location and a final destination. The final destination may be inputted manually by the user, whereas the initial geographic location may be inputted manually or determined automatically based on input from the geographic position device. The turn-by-turn directions may include a set of instructions for maneuvering the client device (and the user) to the destination location. As discussed in more detail below, each turn-by-turn direction or instruction may be associated with an action to be performed by the user in order to follow the route. For example, the user may be required to turn right, turn left, merge, continue on the roadway, etc. These turn-by-turn directions may be communicated to the user audibly through the client device's speaker and/or visually on a display of the client device.

Various operations in accordance with aspects of the invention will now be described. It should be understood that the following operations do not have to be performed in the precise order described below. Rather, various steps can be handled in a different order or simultaneously.

It will be further understood that the sample values, types and configurations of data shown in the figures are for the purposes of illustration only. In that regard, systems and methods in accordance with the present invention may include different data values, types and configurations, and may be provided and received at different times (e.g., via different devices) and by different entities (e.g., some values may be pre-suggested or provided from different sources).

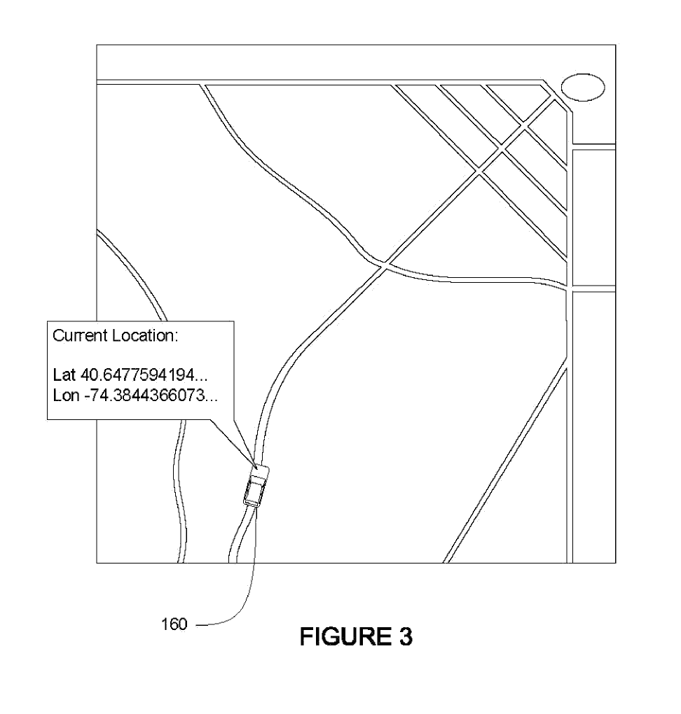

The client device may determine the current location of the device. For example, as shown in FIG. 3, client device 160 may be located a particular geographic location such as on a roadway. As noted above, client device 160 may be used within or incorporated into a vehicle. The client device may determine its geographic location based on input from the geographic position component, for example by identifying latitude and longitude coordinates. This information may be used in conjunction with the map information to determine more specific information such as a street address or even the location of the client device with respect to lane lines of the roadway. It will be understood that although the figure depicts latitude and longitude decimals, as described above, the location of the client device may be expressed in any number of ways.

The determination of a current geographic location may be made continuously or periodically. Thus, as the client device changes location, for example by being physically moved, the geographic position component may determine a new current location.

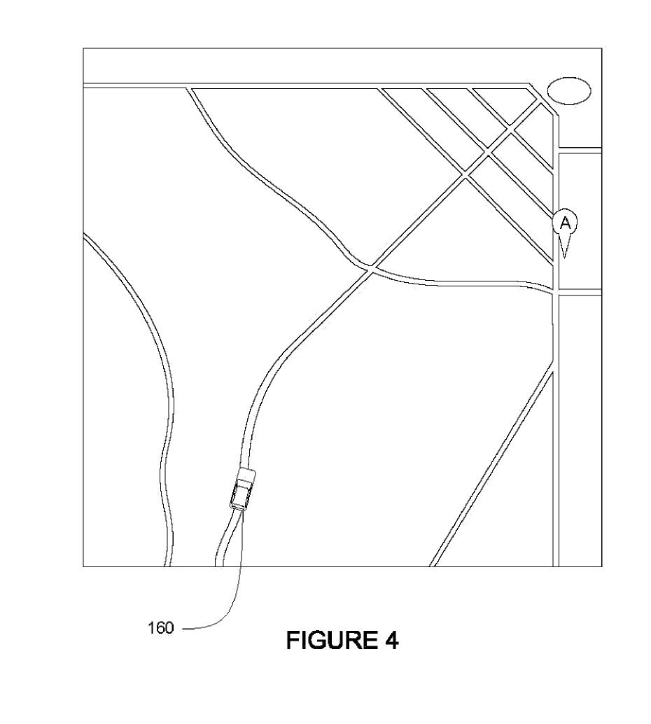

The client device may receive a destination location. For example, the user may input into the client device a destination as a street address, a point of interest, or geolocation coordinates. As described above, the client device may determine its current position based on input from the geographic position component. This current position may be used as the initial location. Alternatively, the user may input the initial location manually. As shown in FIG. 4, the user's destination, may be received by the client device and identified as location A.

The client device, server, or both may determine a route and an ordered set of turn-by-turn directions based on an initial location, the destination location, the map information, and direction data. The route may be made up of a series of instructions (the turn-by-turn directions) to be performed at a particular geographic location by the client device in order to reach the destination. Each turn-by-turn direction or associated action may be further associated with a geographic location along the route at which the client device is to perform the action.

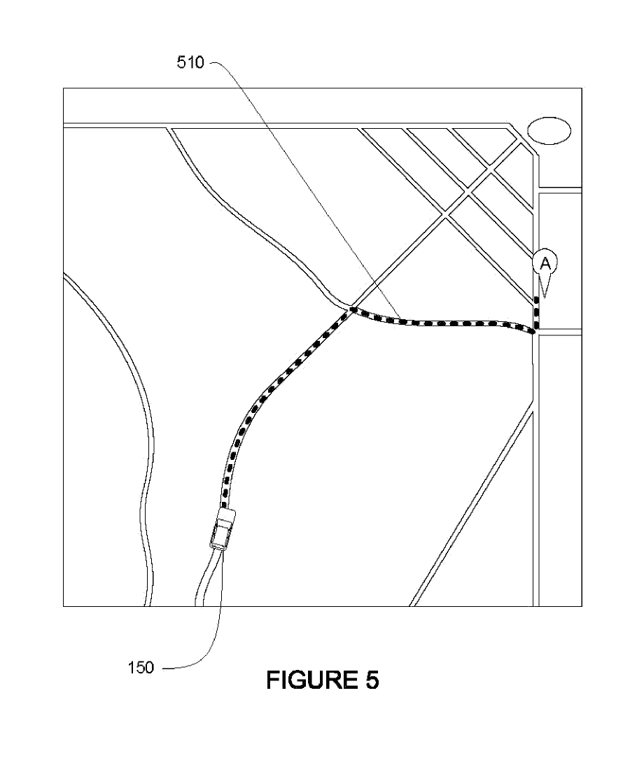

The client device may thus provide the user with an ordered set of turn-by-turn directions or instructions, each with an associated action as described above. As shown in FIG. 5, using the map information, the client device may identify a route 510 based on the current location of client device 160 and the destination location. The client device may then provide the route to the user by displaying the information on the display and/or audibly pronouncing the turn-by-turn directions to the destination. As the client device moves along the route and continues to calculate and update its current location, the client device may display and/or audibly pronounce each successive turn-by-turn direction of the route based on the updated current location.

Again, the client device may identify the next turn-by-turn direction of the ordered set of turn-by-turn directions based on the updated current location. As the client device approaches a certain threshold distance from the geographic location of the next turn-by-turn direction, the client device may determine whether the user has taken some effort to effect the action associated with the next turn-by-turn direction, whether the user is aware of the action, or whether the user has taken an appropriate effort for the action. This threshold distance may be based upon the particular action to be taken and the speed of the client device. In some examples the threshold distance may also be based on the current distance of the client device (or vehicle) to the location of the action as well as other factors such as weather or visibility conditions (e.g., lighting conditions, fog, rain, snow, etc.) and road conditions (e.g., wet from rain or snow, etc.). The client device may identify information regarding conditions by accessing local or remote databases or by receiving updates from various services, for example news, traffic, or meteorological service. The client device may also use sensors, for example a camera mounted on the vehicle, to identify the conditions.

In one example, a longer distance may be required when the action is taking a highway exit when the client device is traveling at 50 miles per hour, and a shorter distance may be required when the action is making a right turn when the client device is traveling 25 miles per hour. Similarly, a longer distance may be required when the road is wet from rain or slick from ice, and a shorter distance may be required when the road is dry and clear. The threshold distance may be a distance along the route as opposed to a linear distance between two points.

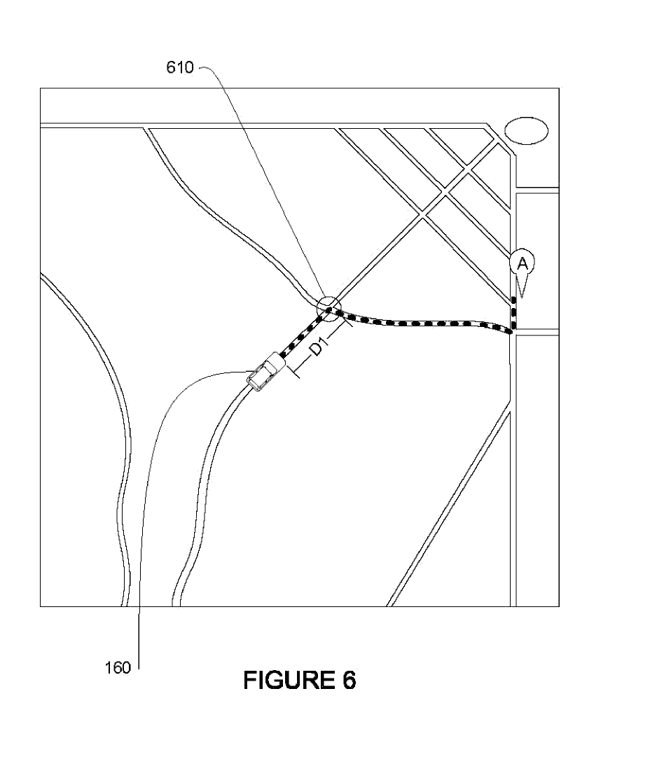

As shown in FIG. 6, client device 160 may approach intersection 610 where the route and turn-by-turn direction require a right turn. The client device may also determine that its current speed is 25 miles per hour. When the client device is within a distance D1 (as based on the right turn and the speed of the client device) from intersection 610, the client device may determine whether the user has taken some step towards completing the required action. In this example, the client device may determine whether the client device (or the user) has turned on a turn signal, for example, by receiving feedback from the feedback devices connected to the vehicle's turn signal. In another example, the client device may determine whether the vehicle is slowing down using, for example, the geopositioning component and/or accelerometer, while approaching the intersection.

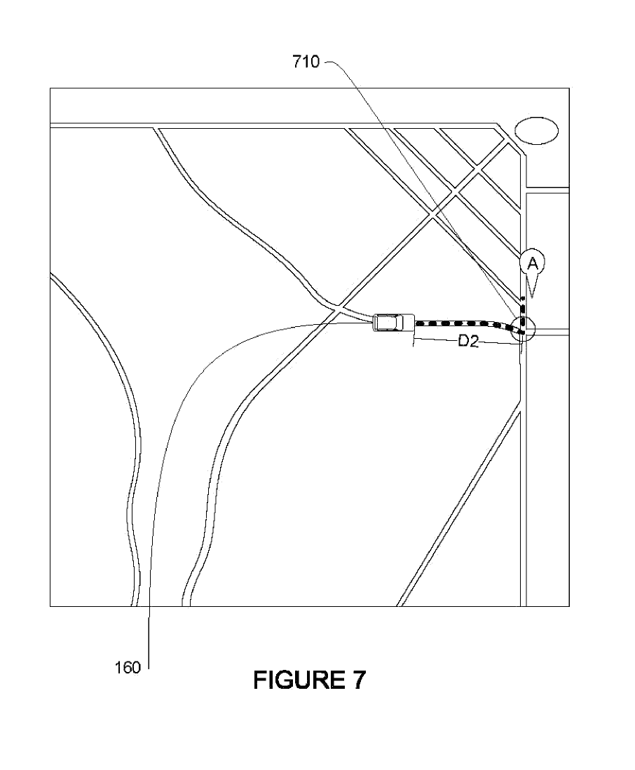

In another example, as shown in FIG. 7, client device 160 may approach intersection 710 where the route and turn-by-turn direction require a left turn from a left-turn only lane. The client device may also determine that its current speed is 40 miles per hour. When the client device is within a distance D2 (as based on the left-turn and the speed of the client device) from intersection 710, the client device may determine whether the client device (or the user) has taken some step towards completing the required action. As the vehicle's speed is now slower and the present turning action is more complicated, the distance D2 of the present example may be greater than the distance D1 of the example of FIG. 6. Again, the client device may determine whether the client device (or the user) has taken some step towards performing the action such as turning on a turn signal or slowing down while approaching the intersection. As described above, the client device may also use feedback from a camera as well as the map information to determine whether the client device is within the turning lane. The client device may also determine whether the it moving into the turning lane or whether the user has taken some step towards moving into the turning lane, such as by slowing down the speed of the client device or using a turn signal.

If the client device has determined that the user has not taken some step towards performing the action, the device may provide the user with feedback. For example, the client device may remind the driver that an action is required in the immediate future by displaying visual cues or audible instructions. The reminders may include verbal (e.g., “You must turn in 50 feet”) or non verbal (e.g., buzzing, chiming, beeping, etc.) audible cues. The reminders may also include physical (haptic) feedback such as small vibrations in the steering wheel or turn signal activator.

In addition to passive monitoring of the various feedback devices, the client device may determine whether the user is taking some initial step based on active feedback from the user. For example, the user may speak an audible command such as “I am turning.” The client device may receive the sound, interpret it as verbal confirmation that the user will take (or has taken) the action, and the client device may determine that the user is indeed taking some step and that no reminder is needed. Similarly, if the client device does not receive verbal confirmation, the client device may provide a reminder.

In another example, the client device may provide the user with feedback if the user takes some incorrect action or misses the action altogether. For example, if the client device is to turn right at the next intersection in order to continue on the route to the destination, and the user activates the left turn signal, the client device may provide the user with audible, visible, or tactile cues as described above indicating that the user is not taking a proper action. In addition, failure to take the action may result in the client device going off-route. In addition to re-routing, or determining the client device's current geographic location and calculating a new route to the destination, the client device may also provide an audible, visible, or tactile cue to the user to indicate that he or she has missed the action.

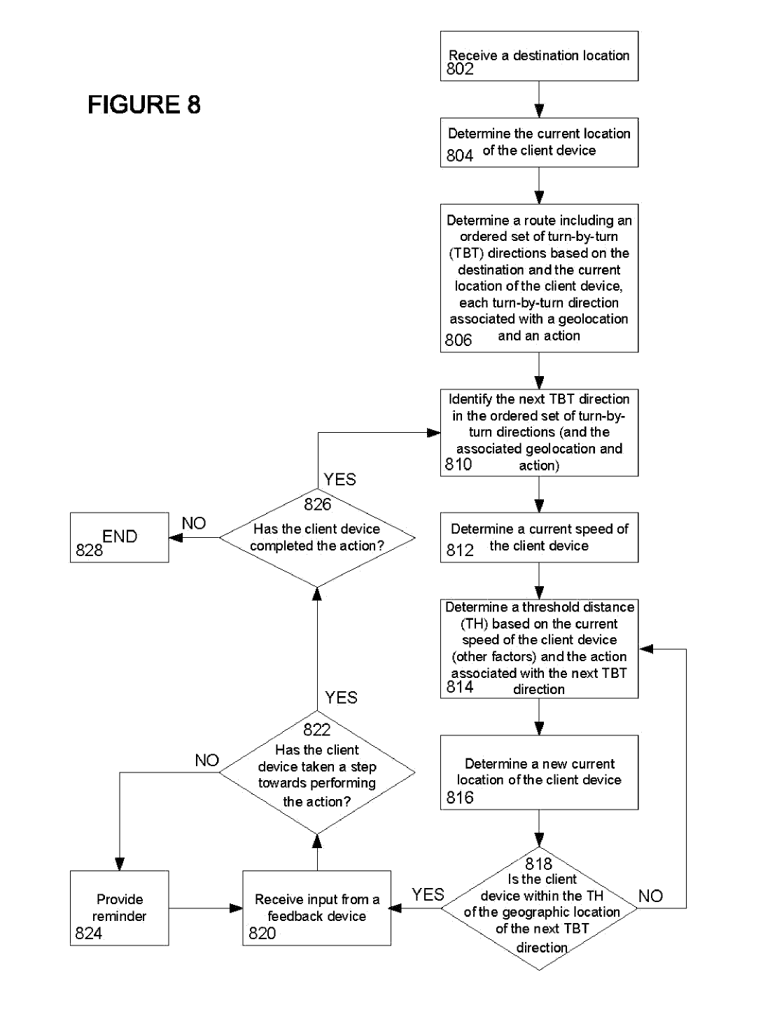

FIG. 8 is an exemplary flow diagram of some of the aspects and features described above. At block 802, the client device receives a destination location. For example, a user may input an address or other geolocation information into the client device. At block 804, the client device determines the current location of the client device, for example, based on input from a geolocation positioning device. Alternatively, the user may also input a current location. At block 806, the client device determines a route including an ordered set of turn-by-turn directions based on the destination location and the current location of the client device. Each turn-by-turn direction is associated with a geographic location and an action.

At block 810, the client device identifies the next turn-by-turn direction in the ordered set of turn-by-turn directions, for example, based on the current location of the client device with respect to the route. The client device may also identify the associated geographic location and action for the next turn-by-turn direction.

The client device also determines its current speed at block 812. Based on the current speed of the client device and the identified action (associated with the next turn-by-turn direction), the client device determines a threshold distance at block 814. As noted above and in box 814, the client device may also consider additional factors such as weather, visual, or road conditions when determining the threshold distance.

At block 816, a new current location of the client device may be determined, again, based on input from the geographic positioning device. It will be understood that this determination may be made periodically or as necessary to perform the steps of FIG. 8. The client device determines, based on its new current location, whether it is within the threshold distance (along the route) from the geographic location associated with the next turn-by-turn direction. If not, the process returns to block 814 to determine the current speed and recalculate the threshold distance at block 816.

Once the client device is within the threshold distance of the geographic location associated with the next turn-by-turn direction, the client device receives input from a feedback device at block 820. For example, the client device may receive information from a microphone or the vehicle's turn signal. At block 822, based on this information, the client device determines whether the client device (or in some examples, the user) has taken some step towards performing the action. The “step” may be dependent upon the type of action. If the client device has not taken any step towards performing the action, the client device may provide a reminder to the user at block 824.

Returning to block 822, once the client device has taken a step towards performing the action, the client device determines whether there is another turn-by-turn direction in the set of turn-by-turn directions. In other words, the client device may determine whether it has reached the destination location. If there is another turn-by-turn direction, the process continues at block 810 to identify a next turn-by-turn direction, etc. If there are no other turn-by-turn directions in the set of turn-by-turn directions, the process ends at block 828. It will be understood that if the action is not taken, the client device or vehicle may no longer be on the correct route; the route may need to be recalculated. In other words, the process may return to block 804 to determine the current location of the client device and, at block 806, determine a new route and associated turn-by-turn directions.

In other aspects, functions described above as being performed by the client device may be performed by the server and transmitted to the client device. For example, the direction data and map tiles may be stored at server 110 and the operations illustrated in FIG. 8 performed by or at the server, client, or both.

While certain aspects of the invention are particularly useful in connection with handheld and portable navigation devices, the systems and methods described herein may also be used in conjunction with vehicle mounted devices. For example, the features described above may also be incorporated into the computer systems of autonomous (self-driving), semi-autonomous, or non-autonomous vehicles.

As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A method of providing a reminder to a user of a navigation device, the method comprising:
receiving a destination location;
periodically determining, by one or more processors, a current location of the navigation device;
determining a route including an ordered set of turn-by-turn directions based on the destination location and the current location of the navigation device, each turn-by-turn direction being associated with a geolocation and a turning action;
identifying a particular turn-by-turn direction of the ordered set of turn-by-turn directions based on the current location of the navigation device;
determining a current speed of the navigation device;
determining a threshold distance to the geolocation associated with the particular turn-by-turn direction based on the current speed of the navigation device and the turning action associated with the particular turn-by-turn direction;
receiving input from a microphone;
when the current location of the navigation device is within the threshold distance of the geographic location associated with the particular turn-by-turn direction, determining, by the one or more processors, based on the input from the microphone whether a step has been taken towards performing the action associated with the particular turn-by-turn direction, wherein the step includes activation of a turn signal; and
when the one or more processors determine that the step has not been taken towards performing the action associated with the particular turn-by-turn direction, generating a reminder to inform the user that the turning action associated with the particular turn-by-turn direction must be completed, wherein the reminder includes a tactile cue.

2. The method of claim 1, wherein the reminder is an audible reminder and the method further comprises playing the reminder through a speaker of the navigation device.

3. The method of claim 1, wherein the reminder is an visual reminder and the method further comprises displaying the reminder on a display of the navigation device.

4-6. (canceled)

7. The method of claim 1, wherein the turning action is turning onto a roadway.

8. The method of claim 1, wherein the turning action is exiting a roadway.

9. The method of claim 1, wherein the threshold distance is a distance along the route.

10. The method of claim 1, wherein the threshold distance is determined based on the road conditions.

11. A computer comprising:
memory;
a geographic positioning device for determining a current location of the computer;
a processor coupled to the memory and operable to:
receive a destination location;
determine a route including an ordered set of turn-by-turn directions based on the destination location and the current location of the computer as determined by the geographic positioning device, each turn-by-turn direction being associated with a geolocation and a turning action;
identify a particular turn-by-turn direction of the ordered set of turn-by-turn directions based on the current location of the computer as determined by the geographic positioning device;
determining a current speed of the computer;
determine a threshold distance to the geolocation associated with the particular turn-by-turn direction based on the current speed of the computer and the turning action associated with the particular turn-by-turn direction;
receive input from a microphone;
when the current location of the computer is within the threshold distance of the geographic location associated with the particular turn-by-turn direction, determine based on the input from the microphone whether a step has been taken towards performing the action associated with the particular turn-by-turn direction, wherein the step includes activation of a turn signal; and
when the computer determines that the step has not been taken towards performing the action associated with the particular turn-by-turn direction, generating a reminder to inform a user that the turning action associated with the particular turn-by-turn direction must be completed, wherein the reminder includes a tactile cue.

12. The computer of claim 11, further comprising a speaker and wherein the reminder is an audible reminder and the processor is further operable to play the reminder through the speaker.

13. The computer of claim 11, further comprising a display and wherein the reminder is a visual reminder and the processor is further operable to display the reminder on the display.

14-16. (canceled)

17. The computer of claim 11, wherein the turning action is turning onto a roadway.

18. The computer of claim 11, wherein the turning action is exiting a roadway.

19. The computer of claim 11, wherein the threshold distance is a distance along the route.

20. The computer of claim 11, wherein the threshold distance is determined based on the road conditions.

21. The method of claim 1 further comprising, when the navigation device determines that the step has been taken towards performing the action associated with the particular turn-by-turn direction, then no reminder is generated to inform the user that the action associated with the particular turn-by-turn direction must be completed.

22. The method of claim 1, wherein the threshold distance is based on a weather condition or visibility condition.

23. The method of claim 22, wherein the weather condition or the visibility condition is identified by using a sensor mounted on a vehicle.

24. The method of claim 22, wherein the weather condition or the visibility condition is identified by one of accessing a remote database or receiving updates from a service.

25. (canceled)

26. (canceled)

27. A method of providing a reminder to a user of a navigation device, the method comprising:
receiving a destination location;
periodically determining, by one or more processors, a current location of the navigation device;
determining a route including an ordered set of turn-by-turn directions based on the destination location and the current location of the navigation device, each turn-by-turn direction being associated with a geolocation and a turning action;
identifying a particular turn-by-turn direction of the ordered set of turn-by-turn directions based on the current location of the navigation device, the particular turn-by-turn direction requiring a vehicle to be in a turn only lane;
determining a current speed of the navigation device;
determining a threshold distance to the geolocation associated with the particular turn-by-turn direction based on the current speed of the navigation device and the turning action associated with the particular turn-by-turn direction;
receiving input from a feedback device;
when the current location of the navigation device is within the threshold distance of the geographic location associated with the particular turn-by-turn direction, determining, by the one or more processors, based on the input from the feedback device whether the vehicle has moved to the turn only lane in order to perform the turning action; and
when the one or more processors determine that the vehicle has not moved into the turn only lane, generating a reminder to inform the user that the turning action associated with the particular turn-by-turn direction must be completed, wherein the reminder includes a tactile cue.

28. The method of claim 27, wherein the feedback device used to determine whether the vehicle has moved to the turn only lane is a camera.

29. The method of claim 1, wherein the tactile cue includes vibrating a component of the vehicle.
